(19) United States
(12) Patent Application Publication
(10) Pub. No.: US 2020/0146113 A1
(43) Pub. Date: May 7, 2020

(54) Base Board Baking Machine with a Diversified Heating Mechanism

(71) Applicant: Tung-Min Lee, Kaohsiung City (TW)

(72) Inventor: Tung-Min Lee, Kaohsiung City (TW)

(21) Appl. No.: 16/177,483

(22) Filed: Nov. 1, 2018

(51) Int. Cl. H05B 3/00; G02F 1/13; H05B 3/22

(52) U.S. Cl. CPC H05B 3/0038; H05B 2203/025; H05B 3/22; G02F 1/1303

(57) ABSTRACT

Abase board baking machine includes a stand, a controller, a housing, a heating mechanism, and a top cover. The heating mechanism includes a heating plate, an infrared heater, and a heated air device. The heating plate in placed in the housing. The infrared heater is mounted on a bottom of the top cover and corresponds to the heating plate. The heated air device is mounted on a side of the housing. Thus, the interior of the housing contains three different heat sources to heat a base board evenly and completely.

### BACKGROUND OF THE INVENTION

### 1. Field of the Invention

The present invention relates to a baking machine and, more particularly, to a base board baking machine.

### 2. Description of the Related Art

A liquid crystal display, such as the TFT-LCD, includes two glass base boards that need to be baked. A conventional base board baking machine in accordance with the prior art shown in FIG. 6 is used to bake a base board 30, and comprises a housing 3 for receiving a hot plate 31 and a heater 311. The hot plate 31 is located above the heater 311. The base board 30 is placed in the housing 3 and located above the hot plate 31. The base board 30 has two edges 301. In operation, the hot plate 31 is heated by the heater 311 so as to heat the base board 30. However, the hot plate 31 cannot keep the base board 30 at a constant temperature during the baking process, thereby decreasing the baking effect of the base board 30, and thereby decreasing the production quality of the base board 30. In addition, the two edges 301 of the base board 30 are easily raised and spaced from the hot plate 31, so that the two edges 301 of the base board 30 are not heated by the hot plate 31, thereby greatly decreasing the quality of the base board 30. Further, the hot plate 31 is divided into multiple baking zones to control the temperature, such that the temperature values of different zones easily interfere with mutually. Further, the conventional base board baking machine has only a single baking mechanism, such that different base board baking machines have different heating manners, thereby affecting the baking quality of the base board 30.

### BRIEF SUMMARY OF THE INVENTION

The primary objective of the present invention is to provide a base board baking machine with a diversified heating mechanism which integrates three heat sources.

In accordance with the present invention, there is provided a base board baking machine comprising a stand, a controller mounted on the stand, a housing mounted on a top of the stand, a heating mechanism mounted in the housing, and a top cover pivotally mounted on and closing the housing. The heating mechanism includes a heating plate, an infrared heater, and a heated air device. The heating plate in placed in the housing. The infrared heater is mounted on a bottom of the top cover and corresponds to the heating plate. The heated air device is mounted on a side of the housing. An interior of the housing contains a first heat source of heat conduction by provision of the heating plate, a second heat source of heat radiation by provision of the infrared heater, and a third heat source of heat convection by provision of the heated air device. Two of the heating plate, the infrared heater, and the heated air device are used to perform heating actions simultaneously. The first heat source, the second heat source, and the third heat source are used selectively, such that the first heat source, the second heat source, and the third heat source are distributed in the housing evenly and completely.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a base board baking machine in accordance with the preferred embodiment of the present invention.

FIG. 2 is a cross-sectional view of the base board baking machine in accordance with the preferred embodiment of the present invention.

FIG. 3 is a schematic operational view of the base board baking machine as shown in FIG. 2 in use.

FIG. 4 is another schematic operational view of the base board baking machine as shown in FIG. 2 in use.

FIG. 5 is another schematic operational view of the base board baking machine as shown in FIG. 2 in use.

FIG. 6 is a cross-sectional view of a conventional base board baking machine in accordance with the prior art.

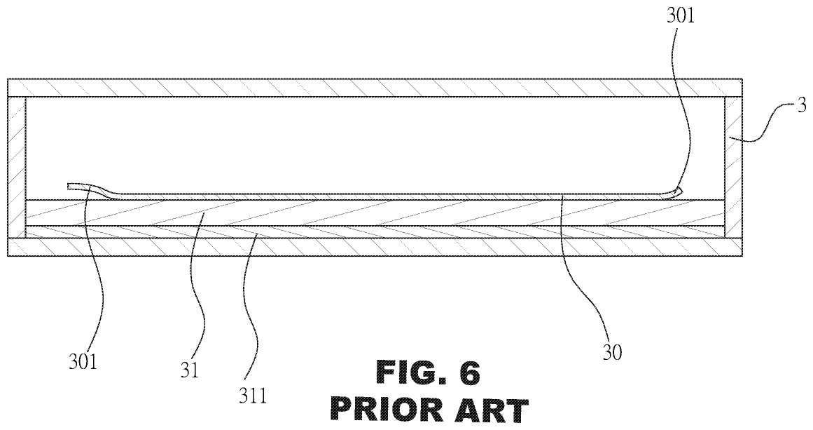

### DETAILED DESCRIPTION OF THE INVENTION

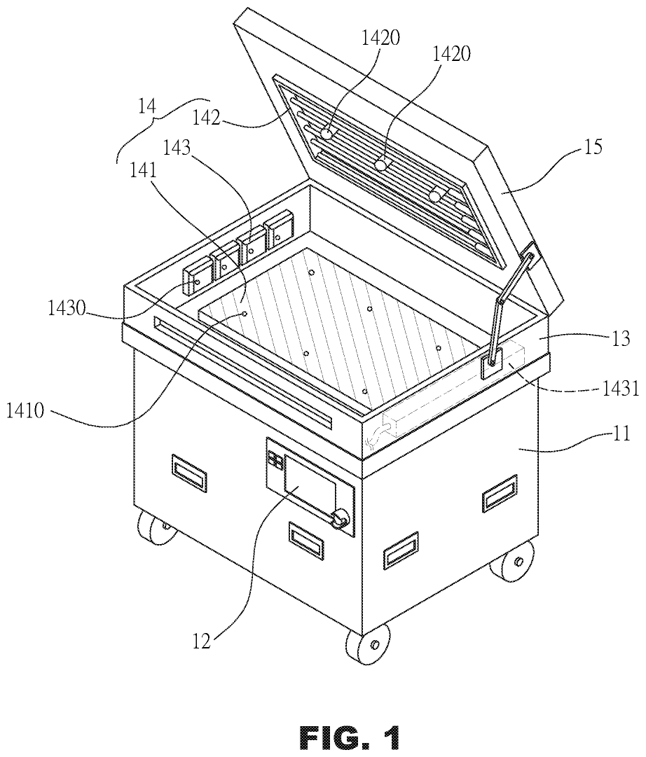

Referring to the drawings and initially to FIG. 1, a base board baking machine in accordance with the preferred embodiment of the present invention comprises a stand 11, a controller 12 mounted on the stand 11, a housing 13 mounted on a top of the stand 11, a heating mechanism 14 mounted in the housing 13, and a top cover 15 pivotally mounted on and closing the housing 13. Preferably, the base board baking machine is a photo-resist baking machine. The controller 12 regulates and sets the heating mechanism 14 at a constant timing, temperature, and quantity. The heating mechanism 14 includes a heating plate 141, an infrared heater 142, and a heated air device 143. The heating plate 141 in placed in the housing 13. The infrared heater 142 is mounted on a bottom of the top cover 15 and corresponds to the heating plate 141. The heated air device 143 is mounted on a side of the housing 13. Thus, an interior of the housing 13 contains a first heat source of heat conduction by provision of the heating plate 141, a second heat source of heat radiation by provision of the infrared heater 142, and a third heat source of heat convection by provision of the heated air device 143. In such a manner, the heating mechanism 14 provides three heat sources, including the heat conduction, the heat radiation, and the heat convection. In practice, two of the heating plate 141, the infrared heater 142, and the heated air device 143 are used to perform heating actions simultaneously. Thus, the first heat source, the second heat source, and the third heat source are used selectively, such that the first heat source, the second heat source, and the third heat source are distributed in the housing 13 evenly and completely.

In the preferred embodiment of the present invention, the heating plate 141 is provided with a plurality of temperature sensors 1410, the infrared heater 142 is provided with a plurality of temperature sensors 1420, and the heated air device 143 is provided with a plurality of temperature sensors 1430. Thus, the temperature sensors 1410, 1420, and 1430 monitor the temperature at each region in the housing 13, to regulate the heat sources of the heating mechanism 14, such that the heat sources of the heating mechanism 14 are fully distributed in the housing 13.

In the preferred embodiment of the present invention, the heating mechanism 14 further includes an air suction member 1431 mounted on another side of the housing 13 and located opposite to the heated air device 143. Thus, the heated air device 143 blows heated air (or hot air), and the air suction member 1431 sucks and drains the heated air, such that the heated air device 143 and the air suction member 1431 form an air convection of the heated air, to accelerate and expand flow of the heated air, such that the heated air is full of the housing 13.

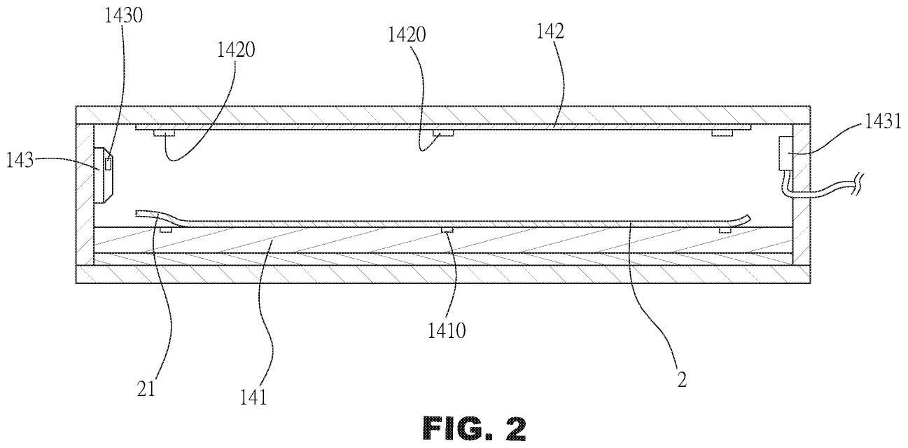

Referring to FIG. 2 with reference to FIG. 1, a base board (or base plate or substrate) 2 is mounted in the housing 13 and placed on the heating plate 141. The base board 2 has two ends 21 that may be raised or curved. In practice, the heating plate 141 is mounted on a lower part of the interior of the housing 13 to provide a planar heat conduction to the base board 2, and the infrared heater 142 is mounted on an upper part of the interior of the housing 13 to emit heat radiation downward, so as to especially heat the top and the two ends 21 of the base board 2. At the same time, the heated air device 143 and the air suction member 1431 are located at two opposite sides of the housing 13. Thus, the heated air device 143 blows the heated air, and the air suction member 1431 sucks the heated air, such that the heated air forms an air convection by cooperation of the heated air device 143 and the air suction member 1431, such that the heated air is evenly full of the housing 13.

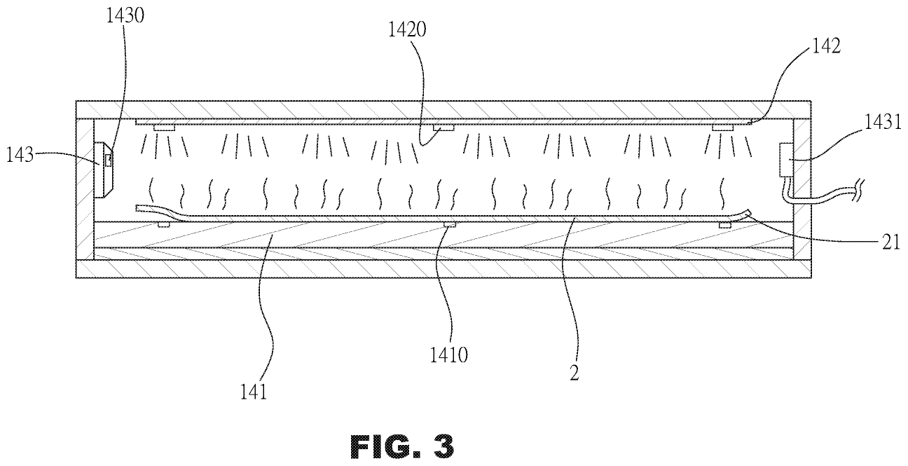

Referring to FIG. 3 with reference to FIG. 1, when the base board 2 is heated, the two ends 21 of the base board 2 may be raised, thereby affecting the heating quality. At this time, the heating plate 141 performs the heat conduction, and the infrared heater 142 performs the heat radiation simultaneously, to heat and bake the base board 2 in the housing 13, such that the base board 2 is heated fully and evenly. At the same time, the temperature sensors 1410 of the heating plate 141, and the temperature sensors 1420 of the infrared heater 142 detect and monitor the temperature at each region of the base board 2. When the temperature at the two ends 21 of the base board 2 is lower than a predetermined value, the infrared heater 142 enhances the heating of the two ends 21 of the base board 2, such that the base board 2 is heated evenly.

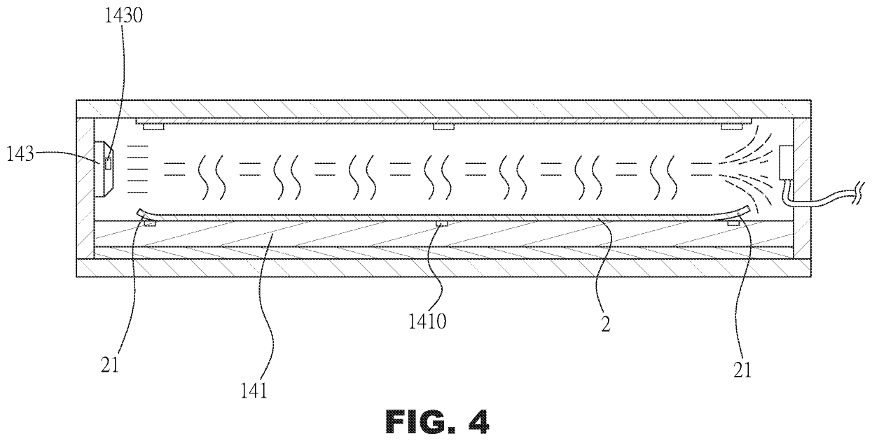

Referring to FIG. 4 with reference to FIG. 1, the heating plate 141 performs the heat conduction, and the heated air device 143 performs the heat convection simultaneously, to heat and bake the base board 2 in the housing 13. At this time, the heated air device 143 especially heats the two ends 21 of the base board 2. At the same time, the temperature sensors 1410 of the heating plate 141 and the temperature sensors 1430 of the heated air device 143 regulate the heat sources, such that the temperature at the two ends 21 of the base board 2 conforms to the whole temperature of the base board 2.

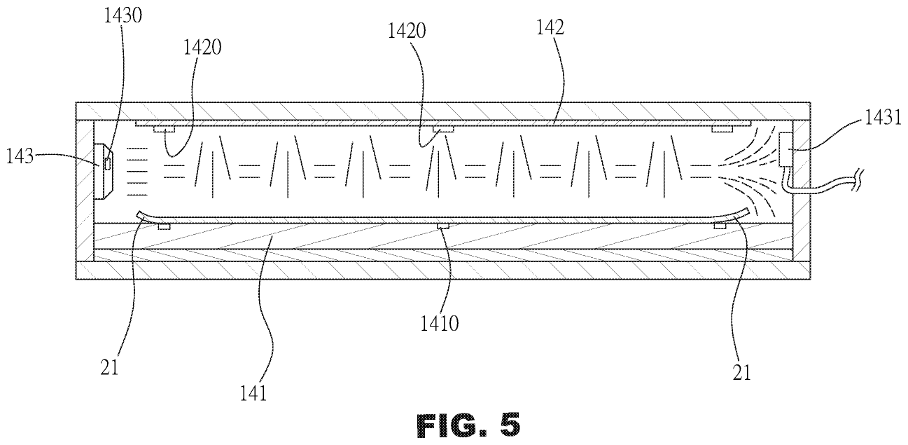

Referring to FIG. 5 with reference to FIG. 1, the infrared heater 142 performs the heat radiation, and the heated air device 143 performs the heat convection simultaneously, to heat and bake the base board 2 in the housing 13. Thus, the top face and the two ends 21 of the base board 2 are heated fully, such that the interior of the housing 13 achieves a heating effect fully and evenly. At the same time, the temperature sensors 1420 of the infrared heater 142 and the temperature sensors 1430 of the heated air device 143 regulate the heat sources, such that the base board 2 is heated averagely, to increase the quality of the base board 2.

Accordingly, the heating mechanism 14 provides the heat conduction, the heat radiation, and the heat convection, while the temperature sensors 1410, 1420, and 1430 of the heating plate 141, the infrared heater 142, and the heated air device 143 overcome mutual interference of the heat sources, such that the base board 2 is heated fully and evenly, to enhance the quality of the base board 2. In addition, the user freely selects the heat sources according to the requirement of baking, to reduce the cost of purchase. Further, the heating plate 141 provides a heat source for the bottom of the housing 13, the infrared heater 142 provides a heat source for the top of the housing 13, and the heated air device 143 provides a heat source for the side face of the housing 13, such that the base board 2 is heated evenly and completely, so as to greatly increase the quality of the base board 2. Further, the controller 12 regulates and sets the different heat sources of the heating mechanism 14 at a constant timing, temperature, and quantity.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A base board baking machine comprising:
a stand;
a controller mounted on the stand;
a housing mounted on a top of the stand;
a heating mechanism mounted in the housing; and
a top cover pivotally mounted on and closing the housing;
wherein:
the heating mechanism includes a heating plate, an infrared heater, and a heated air device;
the heating plate in placed in the housing;
the infrared heater is mounted on a bottom of the top cover and corresponds to the heating plate;
the heated air device is mounted on a side of the housing;
an interior of the housing contains a first heat source of heat conduction by provision of the heating plate, a second heat source of heat radiation by provision of the infrared heater, and a third heat source of heat convection by provision of the heated air device;
two of the heating plate, the infrared heater, and the heated air device are used to perform heating actions simultaneously; and
the first heat source, the second heat source, and the third heat source are used selectively, such that the first heat source, the second heat source, and the third heat source are distributed in the housing evenly and completely.

2. The base board baking machine of claim 1, wherein the heating plate is provided with a plurality of temperature sensors, the infrared heater is provided with a plurality of temperature sensors, and the heated air device is provided with a plurality of temperature sensors.

3. The base board baking machine of claim 1, wherein:
the heating mechanism further includes an air suction member mounted on another side of the housing and located opposite to the heated air device; and
the heated air device blows heated air, and the air suction member sucks and drains the heated air, such that the heated air device and the air suction member form an air convection of the heated air.
